(19) United States
(12) Patent Application Publication
(10) Pub. No.: US 2002/0195565 A1
(43) Pub. Date: Dec. 26, 2002

(54) PET scanner

(75) Inventor: Paul Lecoq, Gex (FR)

Correspondence Address: Dicke, Billig & Czaja, P.A., Suite 1250, 701 Fourth Avenue South, Minneapolis, MN, 55415, US

(73) Assignee: European Organization for Nuclear Research

(21) Appl. No.: 09/892,201

(22) Filed: Jun. 26, 2001

(51) Int. Cl. G01T 1/164

(52) U.S. Cl. 250/363.03

(57) ABSTRACT

A positron emission camera comprising a plurality of scintillators, wherein the scintillators comprise LuAlO₃:Ce (LuAP) based crystals (18,20). In particular, the scintillation crystals (18,20) are LuAP and/or LuYAP.

The present invention relates to a positron emission tomography (PET) camera or scanner.

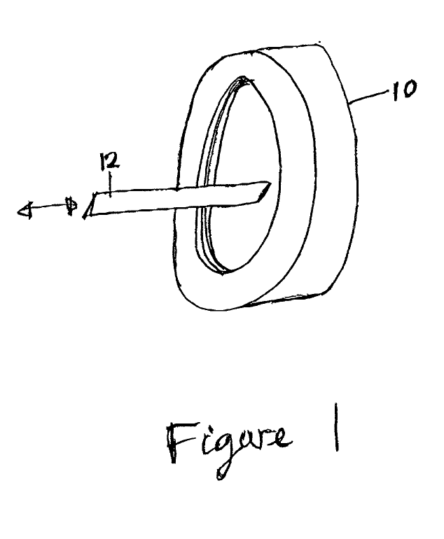

PET scanners are well known in the field of medical physics. These scanners produce images of the body by detecting radiation emitted from radioactive substances injected into the body. Each scanner is made up of radiation detectors, typically called scintillators, which are arranged in a ring configuration around a movable patient table. A typical arrangement with a detector ring 10 and a patient table 12 is shown in FIG. 1. Each scintillator comprises a crystal and has an associated partner located opposite it on the ring. Many known cameras use Bi₄Ge₃O₁₂ (BGO) as a scintillation detector, as taught in U.S. Pat. No. 4,843,245 and EP 0,437,051 B. Each scintillator is connected to a photomultiplier tube, which is in turn connected to read-out electronics.

During a scan the patient is positioned on the movable table in the centre of the ring of detectors. The patient is injected with a radioactive substance, which is tagged with a β⁺ radioactive atom that has a short decay time, for example carbon-11, fluorine-18, oxygen-15 or nitrogen-13. During decay of the nuclei of the radioisotopes, positrons are given off. When a positron is emitted and meets an electron, the collision produces two gamma rays that have the same energy, 511 keV, but travel in opposite directions. By detecting coincidentally the gamma rays generated using scintillators that are diametrically opposed on the ring, the trajectory on which the disintegration occurred can be detected. The scintillator crystals convert the gamma rays to photons of light that are transmitted to the photomultiplier tubes, which convert and amplify the photons to electrical signals. These electrical signals are then processed by a computer to generate three dimensional images of the body over the region of interest (e.g. brain, breast, liver).

An advantage of PET scanning is the ability to determine accurately radionuclide localization and to quantify physiological processes in the body. This can be done because of the emission from the patient's body of two gamma photons that travel in opposite directions. Another advantage is that PET scanners use biological compounds similar or identical to those found in the human body, such as carbon, nitrogen, and oxygen. This means that the PET radionuclides can be substituted directly into biological substances used by the body. In addition, it means that PET tracers do not merely mimic biological pathways as do agents for some other scanners, instead PET tracers actually follow true physiological and metabolic processes. This is advantageous. In contrast, other nuclear medicine imaging techniques require compounds labelled with radioactive nuclides not commonly found in the body. These modified compounds only approximate the true distribution in the human body.

Because of the many advantages inherent in PET scanners, there is a drive to improve their performance, thereby to increase the accuracy of the scanned images and so assist clinicians. To this end, work is presently being done by many groups to improve the characteristics of such scanners.

The most important characteristics of a PET camera are its spatial resolution and sensitivity. Conventional PET cameras can provide spatial resolutions in the range of 4-6 mm at full width half maximum (FWHM) of the emission spectrum. Better spatial resolution requires a large number of scintillation detectors with reduced size, and as a consequence, a large number of photodetectors and associated read-out electronics. This, however, increases the cost. At the same time, new demands on human PET instrumentation, for example on precise brain imaging, require spatial resolution to be better than 2 mm.

The combined formula for a reconstructed image resolution for a PET scanner can be expressed as follows:

Γ=1.25\sqrt{(d/2)²+(0.0022D)²+r²+b²}

Here Γ is the reconstructed image resolution in mm FWHM, d is detector size, D is the detector array diameter, which is typically 600-800 mm for a whole body PET scanner and 250-300 mm for a brain PET (NB including D takes into account photon non-collinearity from positron decay), r is the effective positron range (from 0.5 mm for ³⁸F to 4.5 mm for ⁸²Rb), and b is an additional factor, which is derived from a hit point identification scheme (Anger Logic or “true” position sensitive photo detector, i.e: analog ratios among many photomultiplier signals). Assuming that b is zero for a position sensitive photodetector, it is possible to achieve (with ¹⁸F) Γ=1 mm resolution for brain a PET at d=1 mm.

Assuming that the above equation is accurate, in order to satisfy the growing demand on the spatial resolution and sensitivity of PET cameras, it will be appreciated that the camera has to be made of long, thin detectors with high stopping power. In practice, however, this reduces the spatial resolution at the end of the field of view. This is a disadvantage. To overcome this problem and avoid degradation of the spatial resolution, it is necessary to use a detector with depth of interaction (DOI) determination capability, i.e. the ability to determine the interaction co-ordinate along the detector cell. The most convenient way to do this is to use a multi-layer detector, in which the layers are made of material with different scintillation properties. Because the layers have different characteristics, when a gamma ray is detected it is possible to identify the layer that was hit and so determine more accurately the interaction point.

Many multi-layer detectors are known. For example, U.S. Pat. No. 4,843,245 describes a multi-layer scintillator that uses adjacent BGO and GSO (Gd₂SiO₅) crystals. EP 0,219,648 teaches the use of a three layer scintillator that has an inner layer of BaF₂, a middle layer of GSO and an outer layer of BGO. WO 99/24848 also teaches the use of a multi-layer detector and in particular a “phoswich” detector, in which different detector layers are made of different scintillators with different decay times. The phoswich described in WO 99/24848 has two layers, one each of BGO and Lu₂SiO₅:Ce (LSO).

Another known multi-layer detector uses a combination of LSO and GSO. In this case, hit layer determination is carried out using pulse shape discrimination. This can be done because of the large difference in decay time constants of the LSO and GSO layers. Unfortunately, the photoelectric absorption coefficient of GSO is much less than that of LSO. This means that the stopping power of the GSO is limited, which introduces a degree of uncertainty into the determination of the hit layer.

In yet another known PET, the scintillation detectors are made of layers of “fast” and “slow” LSO scintillators, grown with different cerium concentrations.

As with the LSO and GSO detectors, pulse shape discrimination is used to determine the hit layer. A disadvantage of this particular device is, however, that the difference in decay time constants of “fast”>and “slow” LSO is only about 10% (4-5 nanoseconds at mean value of 40 ns). Hence, there can be difficulty in determining the hit layer with any certainty.

In addition to limitations on the spatial resolution of known PET scanners, there is also a geometrical limitation on the spatial resolution at the end of a PET scanner field of view. This is the so-called radial elongation distortion, which occurs when gamma trajectories cross several scintillation detectors.

An object of the present invention is to provide an improved scintillation detector for a PET camera and an improved PET camera.

Various aspects of the invention are defined in the accompanying independent claims. Some preferred features are defined in the dependent claims.

According to one aspect of the present invention, there is provided a positron emission tomography camera or scanner comprising a patient area, a detector ring for detecting radiation from opposite sides of the patient area, the ring including a plurality of scintillation detectors directed towards the patient area, the scintillation detectors being such as to emit light when radiation is incident thereon, and converting means optically coupled to the scintillation detectors for converting light emitted by the scintillation detectors to electrical pulses, wherein the scintillation detectors comprise LuAlO₃:Ce (LuAP).

The LuAP may include Yittrium to form LuYAP. The amount of Yittrium may be in the range of between 0% and 30% by atomic % of the Lutetium contents.

Preferably, the scintillation detectors additionally comprise LSO. In this case, means are provided for determining whether detected radiation was incident on the LuAP or the LSO. The determining means may be operable to analyse the electrical signal to determine a pulse shape, the pulse shape being indicative of the layer in which the radiation was detected.

A wavelength divider may be provided between each scintillation detector and its associated converting means. The wavelength divider and the converting means are preferably offset relative to the scintillators, so that each wavelength divider and each converting means spans two adjacent scintillators. The wavelength divider may comprise any one or more of a glass filter and/or an interference filter and/or a diffraction grating and/or a prism and/or a diffractive micro-optic array and/or a refractive micro-optic array.

Preferably, the converting means comprise photomultiplier tubes, for example position sensitive photomultiplier tubes or avalanche photodiodes or PIN photodiodes.

According to another aspect of the present invention, there is provided a positron emission tomography camera or scanner including a plurality of scintillators, wherein the scintillators comprise LuAlO₃:Ce (LuAP).

The LuAP may include Yittrium to form LuYAP. The amount of Yittrium may be in the range of between 0% and 30% by atomic % of the Lutetium contents. Preferably, each scintillator has a layer of LSO.

According to yet another aspect of the present invention, there is provided a scintillator for use in a PET scanner, the scintillator comprising LuAP.

The LuAP may include Yittrium to form LuYAP. The amount of Yittrium may be in the range of between 0% and 30% of the Lutetium contents. Preferably, each scintillator further includes a layer of LSO.

According to still another aspect in which the invention is embodied, there is provided a positron emission tomography camera or scanner comprising a plurality of scintillation detectors directed towards a patient area, the scintillation detectors being such as to emit light when radiation is incident thereon, the scintillation detectors comprising two different layers of scintillation material, each of which emits different scintillation light, and converting means optically coupled to the scintillation detectors for converting light emitted by the scintillation detectors to electrical pulses, wherein an optical element is positioned in an optical path between the scintillation detectors and the converting means, the optical element being such that light from one layer of the scintillation detector is affected in one way and light from the other layer of the scintillation detector is affected in another way.

An advantage of this is arrangement is that the scintillation light that is emitted from each of the scintillation layers is affected by the presence of the optical element in different ways, which means that the scintillation hit layer can be more readily identified.

Various cameras and scintillators in which the invention is embodied will now be described by way of example only and with reference to the accompanying drawings, of which:

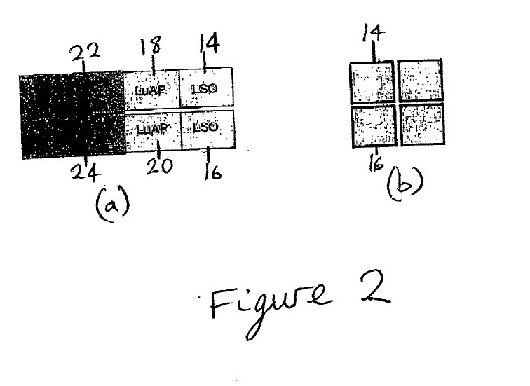

FIG. 2(a) is a side view of a first detector for use in a PET;

FIG. 2(b) is a front view on arrow A of FIG. 2(a);

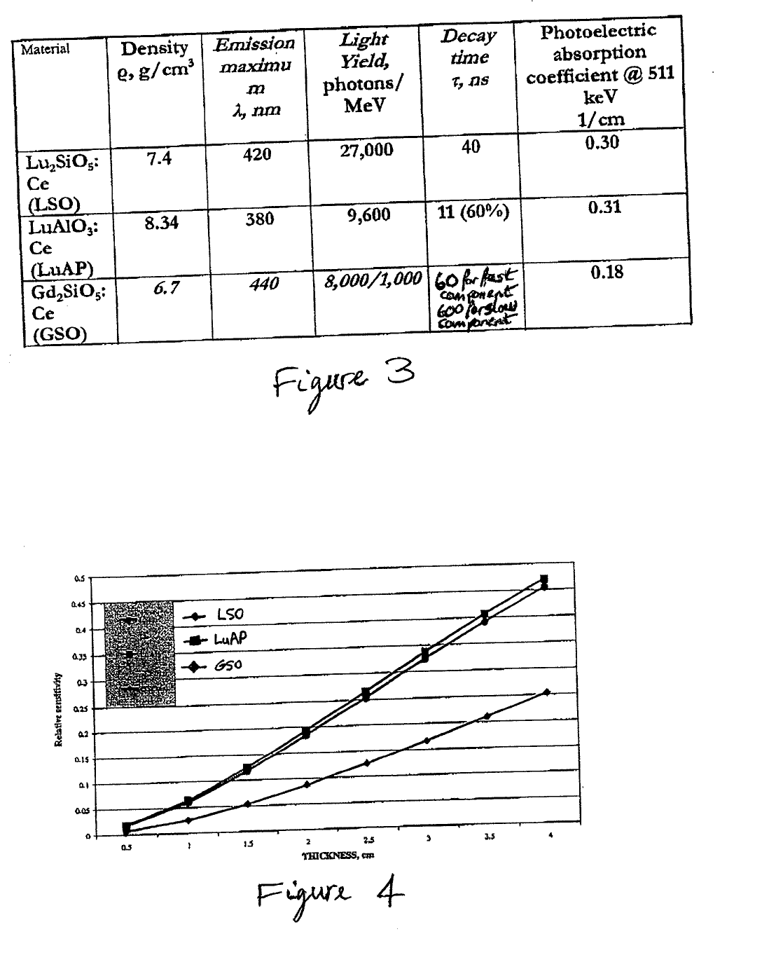

FIG. 3 shows a table that includes various scintillation characteristics of LSO, LuAP and OSO scintillators;

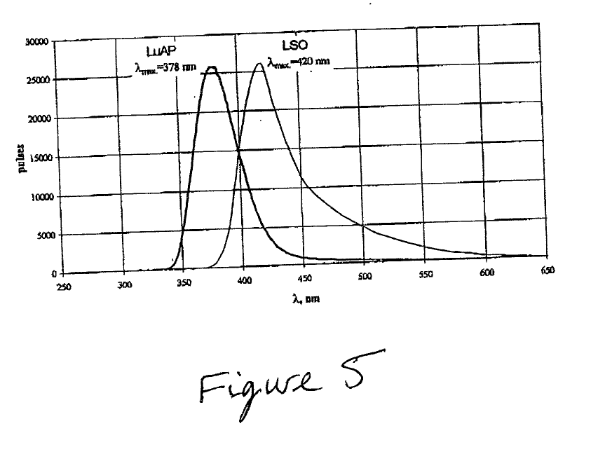

FIG. 4 is a plot of calculated relative sensitivities of PET scanners based on LSO, LuAP and OSO scintillators, at E_{γ}=511 keV, vs crystal thickness;

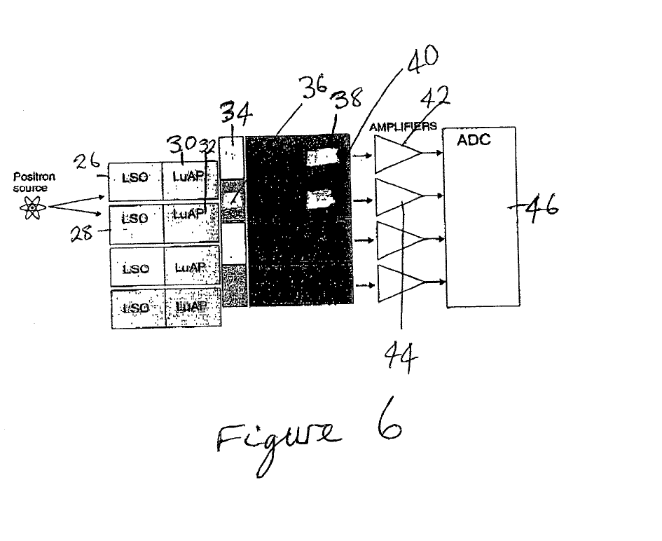

FIG. 5 shows emission spectra for LSO and LuAP, and

FIG. 6 is a block diagram of a second detector for use in a PET.

The PET in which the invention is embodied uses scintillators that comprise lutetium based crystals. In particular, the scintillator in which the invention is embodied uses LuAP or LuYAP. In the following text, the acronym LuAP will represent either LuAP or LuYAP. This material has many properties that make it useful as a scintillator.

FIGS. 2(a) and (b) show two scintillators for a PET scanner, each of which comprises an inner layer of LSO 14,16 and a layer of LuAP 18,20. Each layer of LSO and LuAP is preferably less than 20 m thick. Adjacent each LuAP layer 18, 20 and optically coupled thereto is a photodetector 22,24 for detecting light emitted either from the LSO 14,16 or the LuAP 18,20. The photodetectors 22,24 can be of any suitable type, but typically include photo-multipliers or avalanche photodiodes. Signals from the photodetectors 22,24 are processed using read-out electronics (not shown). In practice, a plurality of the scintillators and photodetectors shown in FIG. 2 are provided in a ring configuration around a patient table, in accordance with conventional layout for PET scanners. Using signals from the photodetectors, an image of the tissue being scanned can be constructed.

The use of LuAP in the scanner of FIGS. 2(a) and (b) provides various benefits. This is because of the advantageous crystal characteristics of LuAP.

Relative properties of LuAP, LSO and GSO are shown in the table of FIG. 3, from which it can be seen that the photoelectric absorption coefficient of LuAP at 511 keV is 0.31, which is comparable to LSO which has a photoelectric absorption coefficient of 0.30. In contrast, the photoelectric absorption coefficient for GSO is 0.18. This means that the effective stopping power of GSO is significantly less than that of either of LSO or LuAP. In addition, the decay constant for LuAP is 11 ns for 60 percent of the emitted light, whereas for LSO it is 40 ns. This is a relatively large difference. This is advantageous for the LSO/LuAP scintillator of FIG. 2, because it means that pulse width discrimination can be used to accurately determine the hit layer. A finer advantage of the LSO/LuAP device of FIG. 2 is that LuAP is transparent to LSO scintillation light. This means that light emitted from the inner LSO layer can pass substantially unimpeded through the LuAP to the photodetector. This improves the sensitivity of the detection process.

Relative sensitivities of PET scanners that use rings of LuAP, LSO and GSO scintillators respectively are shown as a function of crystal thickness in FIG. 4. It should be noted that the relative probability of detecting double coincidence of photo absorption events is taken as a measure of the PET ring sensitivity.

From FIG. 4, it can be seen that the sensitivity of a PET scanner that uses GSO scintillators is much less than that for a scanner using LuAP scintillators (comparing scanners of the same size). Hence, the dual layer LSO/LuAP scintillator of FIG. 2 can be made more sensitive than a conventional LSO/GSO scintillator of the same size. Alternatively, the same sensitivity can be obtained using a significantly thinner LSO/LuAP scintillator. This is advantageous, because it means that the overall size of the PET scanner can be reduced, as can the associated cost. In particular, for a dual layer detector made of LSO/LuAP and a dual layer detector made of LSO/GSO, the same level of sensitivity can be obtained when the LuAP layer is about 1.7 times thinner than a layer of GSO. This means that the PET scanner made of LSO/LuAP has better spatial resolution at the end of the field of view than a scanner made from LSO/GSO and the cost is likely to be lower, because the volume of crystal needed is reduced.

FIG. 5 shows emission spectra for each of LSO and LuAP. From this is can be seen that the LSO spectra has a maximum of 420 nm and the LuAP spectra has a maximum of 378 nm. Hence, if the light detected by the photodetectors of FIG. 2 is at 378 nm, this indicates that the LuAP was hit, whereas if the light detected is at 420 nm, this indicates that the LSO was hit. This means that in addition to using pulse width discrimination, the spectral selection of the emission for the scintillator of FIG. 2 can be used to identify the hit layer. This can be done by detecting the “colour” of the light that reaches the photodetector. FIG. 6 shows a detector that is adapted to detect the colour of the light.

FIG. 6 shows plurality of like scintillators for a PET camera, each of which has a LSO layer 26,28 and a LuAP layer 30,32. As before, each layer of LSO 26,28 and LuAP 30,32 is preferably less than 20 mm thick. Adjacent the scintillators are a plurality of wavelength division elements 34,36. Each of these is physically offset relative to the scintillators, so that it spans, by equal amounts, two adjacent scintillation detectors. Adjacent wavelength dividers 34 and 36 have different transmission coefficients. This means that the end of each scintillator is adjacent two different wavelength dividers 34 and 36. The wavelength division elements 34 and 36 can be made of coloured glass filters. In the example of FIG. 6, filter 34 is transparent for light emissions from both of the LSO and the LuAP layers 26 and 30 respectively, whereas filter 36 is transparent for emissions from the LuAP layer 26 and semi-transparent for emissions from the LSO layer 26. Hence, whilst the filter 34 affects light from the different scintillation layers to the same extent, the filter 36 affects light from the LuAP layer in one way and light from the LSO layer in another way.

To detect scintillation light from the scintillators of FIG. 6, photodetectors 38 and 40 are optically coupled to the wavelength dividers 34,36. Each photodetector 38,40 is physically offset relative to the scintillation detectors, but substantially in line with its associated wavelength divider 34,36, so that it spans two adjacent scintillation detectors. Coupled to each photodetector 38,40 is an amplifier 42,44 for amplifying its output. Signals from the amplifiers 42,44 are output to an analogue to digital converter 46 for processing. The processed signals are used to construct an image of the material being scanned.

To provide a PET scanner, a plurality of the scintillators and photodetectors shown in FIG. 6 are provided in a ring configuration around a patient table, in accordance with the conventional practice.

When the LuAP detector 30 of FIG. 6 is hit, the amplitudes of the electrical pulses from photodetectors 38 and 40 are equal. This is because the wavelength dividers 34 and 36 are each transparent to LuAP scintillation light. In contrast, when the LSO detector 26 is hit, the amplitude of the electrical pulse from the photodetector 38 is higher than that of photodetector 40. This is because the wavelength divider 34 is transparent to LSO scintillation light, whereas the wavelength divider 36 is only semi-transparent to such light. Hence, by comparing the amplitudes of the pulses detected by the photodetectors, the hit layer can be identified.

Whilst the wavelength dividers 34 and 36 of FIG. 6 comprise a glass filter, they could equally be any one or more of an interference filter and/or a diffraction grating and/or a prism and/or a diffractive micro-optic array and/or a refractive micro-optic array.

In summary, the present invention is directed to the use of a new high-sensitivity crystal, LuAP or LuYAP, which when applied to a PET camera provide greater image sharpness, due to the decreased size of the scintillation detector. The PET is less expensive, more sensitive and has relatively low angulation degradation of the spatial resolution, thereby allowing the diameter of the detector ring to be decreased, which in turn reduces the overall cost of the camera. Furthermore, in a dual layer configuration the large difference in decay time constants of LSO and LuAP (40 ns and 11 ns for 60 percent of the emitted light respectively) makes pulse shape discrimination a useful option and allows effective hit layer determination.

A skilled person will appreciate that variations of the disclosed arrangements are possible without departing from the invention. Accordingly, the description of the specific embodiments is made by way of example and not for the purposes of limitation. It will be clear to the skilled person that minor modifications can be made without significant changes to the operation described above.

What is claimed is:

1. A positron emission tomography camera or scanner comprising:
a patient area,
a detector ring for detecting radiation from opposite sides of the patient area, the ring including a plurality of scintillation detectors directed towards the patient area, the scintillation detectors being such as to emit light when radiation is incident thereon, and
converting means optically coupled to the scintillation detectors for converting light emitted by the scintillation detectors to electrical pulses,
wherein the scintillation detectors comprise LuAP.

2. A camera or scanner as claimed in claim 1, wherein the scintillation detectors comprise another layer of scintillating crystal.

3. A camera or scanner as claimed in claim 2, wherein determining means are provided for determining whether detected radiation was incident on the LuAP or the other layer of scintillating material.

4. A camera or scanner as claimed in claim 3, wherein the determining means are operable to analyze the electrical signal to determine a pulse shape, the pulse shape being indicative of the layer in which the radiation was detected.

5. A camera or scanner as claimed in claim 2, wherein an optical element is provided between each scintillation detector and its associated converting means, the optical element being such that light from the LuAP is affected in one way and light from the other layer of scintillating crystal is affected in another way.

6. A camera or scanner as claimed in claim 5, wherein the optical element and the converting means are offset relative to the scintillator, so that each optical element and each converting means spans two adjacent scintillators.

7. A camera or scanner as claimed in claim 5, wherein the optical element is a wavelength divider, preferably comprising a glass filter and/or an interference filter and/or a diffraction grating and/or a prism and/or a diffractive micro-optic array and/or a refractive micro-optic array.

8. A camera or scanner as claimed in claim 1, wherein the converting means comprise photomultiplier tubes.

9. A camera or scanner as claimed claim 8, wherein the photomultiplier tubes are position sensitive.

10. A camera or scanner as claimed in claim 1, wherein the converting means comprise photodiodes and/or avalanche photodiodes.

11. A camera or scanner as claimed in claim 10, wherein the photodiodes and/or avalanche photodiodes are made of silicon.

12. A positron emission tomography camera or scanner comprising:
a patient area,
a detector ring for detecting radiation from opposite sides of the patient area, the ring including a plurality of scintillation detectors directed towards the patient area, the scintillation detectors being such as to emit light when radiation is incident thereon, and
converting means optically coupled to the scintillation detectors for converting light emitted by the scintillation detectors to electrical pulses,
wherein the scintillation detectors comprise LuYAP.

13. A camera or scanner as claimed in claim 12, wherein the scintillation detectors comprise another layer of scintillating crystal.

14. A camera or scanner as claimed in claim 13, wherein determining means are provided for determining whether detected radiation was incident on the LuYAP or the other layer of scintillating crystal.

15. A camera or scanner as claimed in claim 14, wherein the determining means are operable to analyze the electrical signal to determine a pulse shape, the pulse shape being indicative of the layer in which the radiation was detected.

16. A camera or scanner as claimed in claim 12, wherein an optical element is provided between each scintillation detector and its associated converting means, the optical element being such that light from the LuYAP is affected in one way and light from the other layer of the scintillation detector is affected in another way.

17. A camera or scanner as claimed in claim 16, wherein the optical element and the converting means are offset relative to the scintillator, so that each wavelength divider and each converting means spans two adjacent scintillators.

18. A camera or scanner as claimed in claim 16, wherein the optical element comprises a glass filter and/or an interference filter and/or a diffraction grating and/or a prism and/or a diffractive micro-optic array and/or a refractive micro-optic array.

19. A camera or scanner as claimed in claim 12, wherein the converting means comprise photmultiplier tubes.

20. A camera or scanner as claimed claim 19, wherein the photomultiplier tubes are position sensitive.

21. A camera or scanner as claimed in claim 12, wherein the converting means comprise photodiodes and/or avalanche photodiodes.

22. A camera or scanner as claimed in claim 21, wherein the photodiodes and/or avalanche photodiodes are made of silicon.

23. A positron emission tomography camera or scanner comprising a plurality of scintillators, wherein the scintillators comprise LuAlO₃:Ce (LuAP).

24. A camera or scanner as claimed in claim 23, wherein the scintillators additionally comprise a layer of LSO positioned adjacent the LuAP.

25. A positron emission tomography camera or scanner comprising a plurality of scintillators, wherein the scintillators comprise LuYAlO₃:Ce (LuYAP).

26. A camera or scanner as claimed in claim 25, wherein the scintillators additionally comprise a layer of LSO positioned adjacent the LuYAP.

27. A scintillator for use in the camera or scanner as claimed in claim 1, wherein the scintillator comprises LuAP.

28. A scintillator for use in the camera or scanner as claimed in claim 12, wherein the scintillator comprises LuAP.

29. A scintillator for use in the camera or scanner as claimed in claim 12, wherein the scintillator comprises LuYAP.

30. A scintillator for use in the camera or scanner as claimed in claim 1, wherein the scintillator comprises LuYAP.

31. A positron emission tomography camera or scanner comprising:
a plurality of scintillation detectors directed towards a patient area, the scintillation detectors being such as to emit light when radiation is incident thereon, the scintillation detectors comprising two different layers of scintillation material, each of which emits different scintillation light, and
converting means optically coupled to the scintillation detectors for converting light emitted by the scintillation detectors to electrical pulses,
wherein an optical element is positioned in an optical path between the scintillation detectors and the converting means, the optical element being such that light from one layer of the scintillation detector is affected in one way and light from the other layer of the scintillation detector is affected in another way.

32. A camera or scanner as claimed in claim 31, wherein the optical element spans two adjacent scintillation detectors.

33. A camera or scanner as claimed in claim 32, wherein adjacent the optical element is secondary optical element that covers a part of the scintillation layer that is also covered by the optical element, wherein the secondary optical element affects light from each of the different scintillation layers in the same way.

34. A camera or scanner as claimed in claim 31, wherein the optical element comprises a glass filter and/or an interference filter and/or a diffraction grating and/or a prism and/or a diffractive micro-optic array and/or a refractive micro-optic array.

35. A camera or scanner as claimed in claim 2, wherein the other layer comprises LSO.

36. A camera or scanner as claimed in claim 13, wherein the other layer comprises LSO.
